(19) United States
(12) Patent Application Publication
(10) Pub. No.: US 2010/0170590 A1
(43) Pub. Date: Jul. 8, 2010

(54) MANUFACTURING A PIPING ELEMENT, AND PIPING ELEMENT

(75) Inventor: Rauno Juuti, Nastola (FI)

Correspondence Address: OCCHIUTI ROHLICEK & TSAO, LLP, 10 FAWCETT STREET, CAMBRIDGE, MA, 02138, US

(73) Assignee: UPONOR INNOVATION AB, Fristad (SE)

(21) Appl. No.: 12/601,342

(22) PCT Filed: May 22, 2008
(86) PCT No.: PCT/FI2008/050296

§ 371 Date: Nov. 23, 2009

(30) Foreign Application Priority Data
May 23, 2007 (FI) 20075370

(51) Int. Cl. F16L 59/14; B29C 63/04; F16L 11/11; F16L 59/153

(52) U.S. Cl. 138/121; 156/194; 156/433; 138/137; 138/149; 138/111

(57) ABSTRACT

A piping element (1) comprises at least one flow pipe (4), an insulator (3) arranged outside it and a corrugated outer sheath (2) arranged outside the insulator (3) in such a way that the piping element (1) is bendable in its entirety. The outer diameter of the insulator (3) is reduced before conducting it to a corrugator (13) inside the outer sheath (2). In the corrugator (13), the insulator (3) reverts towards its larger outer diameter. The free outer diameter of the insulator layer is formed larger than the smallest inner diameter of the outer sheath (2).

### BACKGROUND OF THE INVENTION

The invention relates to a piping element comprising at least one elongated element, outside of which there is an insulator and outside of which there is a corrugated outer sheath, whereby the piping element is bendable.

Further, the invention relates to a method of manufacturing a piping element, the method comprising feeding at least one elongated element, arranging an insulator outside it, conducting the elongated element and the insulator arranged outside it into a corrugator, and forming an outer sheath corrugated with the corrugator outside the insulator.

Further still, the invention relates to an apparatus for manufacturing a piping element, the apparatus comprising means for feeding at least one elongated element, means for arranging an insulator outside the elongated element, and an extruder as well as a corrugator for forming a corrugated outer sheath outside the insulator.

District heating networks, for example, utilize piping elements having one or more flow pipes in the innermost part, and an insulator surrounding it. Outside the insulator, there is a corrugated outer sheath. One such piping element is disclosed in US publication 4929409, for example. Such a piping element has very good ring stiffness, whereby it is particularly well applicable to underground installations, for instance in district heating networks. The piping element is also flexible, whereby it can be wrapped in a coil for storage and transport. Also known in district heating use are piping elements in which polyurethane foam has been foamed outside the flow pipes and an outer sheath formed outside the polyurethane foam. Due to the polyurethane foam, such a piping element is stiff and inflexible, whereby transporting, installing and handling them is rather difficult and inconvenient.

Publication JP 02057790 discloses a heat-insulated pipe having an inner pipe and an insulator layer arranged upon it. A corrugated outer layer has been slid to the outside of the insulator layer. The outer surface of the insulator layer is provided with protrusions of the shape of a pyramid or with ridges in the axial direction. When the corrugated outer layer is being slid onto the insulator layer, pressure medium, such as air, is simultaneously blown to the space between the outer layer and the insulator layer.

### BRIEF DESCRIPTION OF THE INVENTION

An object of the invention is to provide an improved piping element as compared with previous ones, as well a method and an apparatus for manufacturing it.

The piping element according to the invention is characterized in that the free outer diameter of the piping element insulator is larger throughout than the smallest inner diameter of the corrugated outer sheath.

The method according to the invention is characterized by arranging the free outer diameter of the insulator to be larger throughout than the smallest inner diameter of the corrugated outer sheath, and by reducing the outer diameter of the insulator temporarily before conducting it into the corrugator, whereby the outer sheath is formed upon the insulator and the insulator reverts towards its larger outer diameter, pressing against the inner surface of the outer sheath.

Further, the apparatus according to the invention is characterized in that the apparatus comprises means for reducing the outer diameter of the insulator temporarily, the means being arranged before the corrugator.

In the presented solution, the piping element comprises at least one elongated element, such as a flow pipe, an insulator arranged outside it and a corrugated outer sheath arranged outside the insulator in such a way that the piping element is flexible in its entirety. The free outer diameter of the insulator layer of the piping element is larger throughout than the smallest inner diameter of the corrugated outer sheath. Thus, the insulator presses tightly against the outer sheath. Thus, for example, if there is a hole in the outer sheath through which water gets in, the water cannot proceed inside the piping element between the outer sheath and the insulator. Further, the insulator layer is tightly positioned in the piping element, whereby the piping element is throughout firm and clean-cut.

The idea of an embodiment is that a watertight layer is arranged outside the insulator layer, between the insulator layer and the outer sheath. Such a watertight layer protects the insulator layer against getting wet. Particularly preferably, there is, between the insulator layer and the outer sheath, a layer welding/gluing the insulator layer and the outer sheath together. Such a layer is extremely reliable in ensuring the tightness between the insulator layer and the outer sheath.

### BRIEF DESCRIPTION OF THE FIGURES

The invention will be described in greater detail in the attached drawings, in which

FIG. 1 shows schematically a side view and a partial cross-section of an apparatus for manufacturing a piping element; and

FIG. 2 shows schematically a side view and a cross-section of a piping element.

In the figures, some embodiments of the invention are shown simplified for the sake of clarity. Similar parts have been denoted with the same reference numerals in the figures.

### DETAILED DESCRIPTION OF SOME EMBODIMENTS OF THE INVENTION

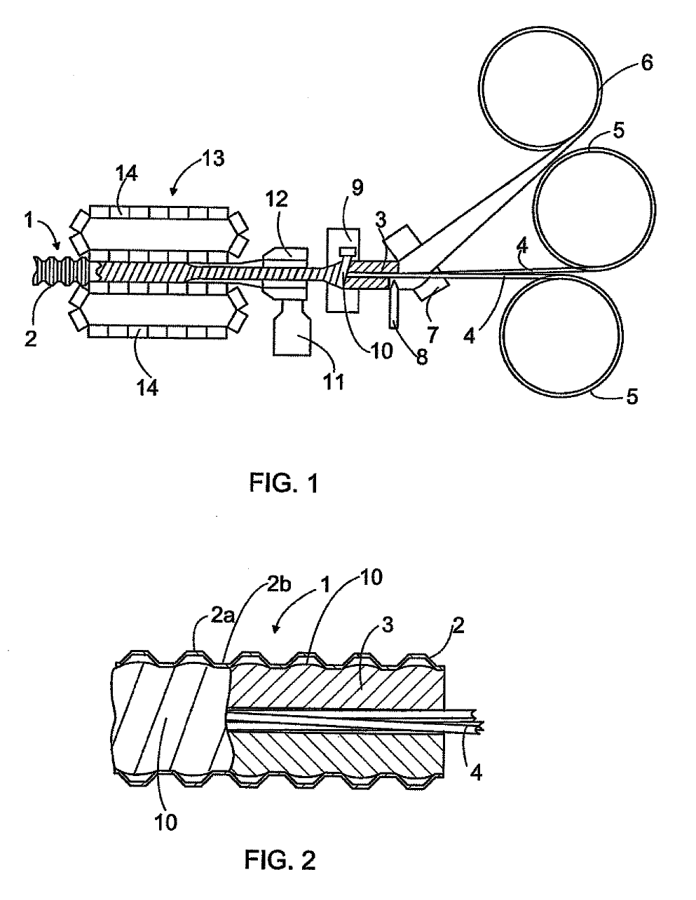

FIG. 1 shows an apparatus for manufacturing a piping element. The piping element 1 has a corrugated outer sheath 2. Inside the outer sheath 2, there is an insulator 3. Inside the insulator 3, there are flow pipes 4. There may be one or more flow pipes 4. The piping element 1 may have, in addition to or instead of flow pipes 4, elongated elements, such as a cable, a protective pipe and/or a supportive member to support the other elongated elements.

The flow pipes 4 are manufactured in advance and wound in a coil 5. The apparatus thus comprises means for feeding the flow pipes 4 from the coil 5, but these means that support the coil 5 and allow the flow pipes 4 to be fed are not, for the sake of clarity, shown in the attached figure.

The insulator 3 is a prefabricated insulator and it is in a plate-like form on a coil 6. For clarity, FIG. 1 does not show means for supporting or rotating the coil 6. From the coil 6, the insulator 3 in a plate-like form is fed via a wrapping device 7, whereby the plate-like insulator 3 is wrapped around the flow pipes 4. The sides of the plate-like insulator 3 are combined with a welding device 8. The seam formed by sides of the plate-like insulator 3 that are against each other is, for example, melted closed with hot air in such a way that the insulator 3 is, in its entirety, around the flow pipes 4. Instead of utilizing hot air, the welding device 8 may melt the seam in another way known as such. Instead of a welding device 8, for example a gluing device may as well be used for combining the sides of the plate-like insulator.

After this, the flow pipes 4 and the insulator 3 are fed via a winding device 9, where plastic foil 10 is wound around the insulator 3 with the winding device 9. Since the flow pipes 4 and the insulator 3 move continuously forwards in the apparatus, i.e. to the left in FIG. 1, and the winding device 9 rolls plastic foil roll around the insulator 3, the plastic foil 10 becomes positioned around the insulator 3 in the shape of a helical curve or a spiral.

The plastic foil 10 is used to reduce the outer diameter of the insulator 3. The flow pipes 4 and the insulator wound around them and having an outer diameter reduced by the plastic foil 10 are conducted through the nozzle 12 of an extruder 11. In FIG. 1, reducing the outer diameter is illustrated in an exaggerated manner. With the extruder 11 and the nozzle 12, a plastic layer is extruded to the outside of the insulator 3 and the plastic foil 10, a corrugated outer sheath 2 being formed of this plastic layer in a corrugator 13 for the piping element 1. The corrugator 13 has two moving chill moulds 14 in a manner known as such. The structure and operation of the extruder 11, nozzle 12 and corrugator 13 are not explained in more detail in this context because these aspects are completely familiar to a person skilled in the art.

The inside temperature of the corrugator 13 is so high, typically on the order of 165 to 175° C., that the plastic foil 10 softens, thus stretching and allowing the insulator to revert towards its larger outer diameter. Since the outer diameter of the insulator 3 has been reduced before the corrugator 13, its original free outer diameter before the plastic foil 10 has been wound around it may be larger throughout, i.e. at every point, than the smallest inner diameter of the corrugated outer sheath 2. Thus, the insulator 3 reverts in the corrugator 13 towards its larger diameter, pressing against the inner surface of the outer sheath 2.

The corrugated outer sheath 2 consists of successive ridges 2a and grooves 2b that are typically circular. If desired, a ridge 2a and a groove 2b may also be shaped continuous as a helical curve. The smallest inner diameter of the corrugated outer sheath 2 is at the point of the grooves 2b. Thus, the insulator 3 is tightly pressed against the inner surface of the corrugated outer sheath 2 at the point of the grooves 2b, whereby the insulator 3 is tightly against the inner surface of the outer sheath 2 at the point of the grooves 2b the whole way around the piping element. Thus, for example, water cannot flow between the insulator 3 and the outer sheath 2 in the axial direction of the piping element. At the point of the ridges 2a, the insulator 3 can expand to a size greater than the smallest inner diameter of the outer sheath 2, as shown in FIG. 2.

In the corrugator 13, the plastic foil 10 is heated so much that it melts at least partly, gluing/welding thus the insulator 3 closely to the inner surface of the outer sheath 2.

The thickness of the plastic foil 10 may be, for example, between 20 μm and 100 μm. Thin plastic foil may be, due to the effect of the heat, invisible after the corrugator but it may still weld the insulator 3 sufficiently tightly against the inner surface of the outer sheath 2. Thicker plastic foil also remains visible after the heating in such a way that the watertightness of the layer formed by it can be visually examined.

Preferably, the plastic foil 10 is coiled in such a way that a new turn becomes partly positioned upon the preceding layer, in other words the edges overlap. Thus, it is ensured that the plastic foil provides a watertight layer. The plastic foil 10 can also be coiled in such a way that there remains a slot between the layers, whereby the plastic foil does not form a layer upon the whole insulator 3, but this solution still allows the outer diameter of the insulator 3 to be reduced before the corrugator and thus the insulator 3 to be pressed tightly against the inner surface of the outer sheath 2. The thickness of the layer provided by the plastic foil 10 can also be affected by controlling the number of turns of the winding device 9, which makes it thus possible to control the extent to which successive layers overlap. The shrink force of the plastic foil 10, i.e. the extent to which the insulator 3 is compressed, can be controlled by controlling the braking force of the winding device 9. The free outer diameter of the insulator 3 can be formed for instance 3 to 20 mm thicker throughout, i.e. at every point, than the smallest inner diameter of the outer sheath 2, which is at the point of the groove 2b. The smallest inner diameter of the outer sheath 2 can vary between 50 and 300 mm, for instance.

The material of the plastic foil 10 may be low density polyethylene PE-LD, for example, and its thickness 20 to 200 μm, for example. In such a case, the width of the plastic foil 10 may, in turn, be for instance 50 to 200 mm.

The insulator 3 is most preferably made of cross-linked closed-cell polyethylene foam. The insulator 3 may be formed of several prefabricated insulator plate layers. The thicknesses of the different layers may be equal. Naturally, the width of a layer to be wrapped in an outer location must be greater than the width of an insulator layer to be wrapped in an inner location.

The corrugated outer sheath 2 is most preferably formed of polyethylene PE. Most preferably, the flow pipes 4, the insulator 3 and the outer sheath are all manufactured of either cross-linked or conventional polyethylene. Thus, for example, it is simple and easy to handle the piping element in connection with recycling. It is, of course, feasible to use other materials as well. For instance the insulator 3 may also be made of foamed polypropylene. Correspondingly, the outer sheath 2 may also be made of polypropylene.

Forming the outer sheath 2 corrugated makes the ring stiffness of the piping element rather good, for example 8 to 12 kN/m². The piping element 1 is particularly well applicable to being buried in the ground. The objects of use may be, for example, district heating networks and water supply systems. Owing to corrugation and the softness of the insulator 3, the piping element is, nevertheless, bendable. The piping element 1 being bendable means that the piping element may be wrapped in a coil for storage and transport, and unwrapped in connection with installation. The outer diameter of the piping element 1 may typically be between 100 and 300 mm. Such piping elements 1 may be wound in a coil with a diameter of 0.8 to 3 m, for example, for storage and transport.

In some cases, features presented in this application may be used as such, irrespective of other features. On the other hand, features presented in this application may, if required, be combined to provide different combinations.

The drawings and the related specification are only intended to illustrate the idea of the invention. Details of the invention may vary within the scope of the claims.

Instead of using a winding device and plastic foil, the outer diameter of the insulator layer may temporarily be reduced by, for instance, conducting a flow pipe and an insulator arranged outside it through a reducing cone reducing the outer diameter of the insulator layer. Hence, the outer diameter of the insulator layer is reduced in the reducing cone and reverts, owing to the memory of the material, towards its original free outer diameter against the inner surface of the outer sheath 2. Further, the outer diameter of the insulator may be reduced by extruding to the outer surface of the insulator a layer shrinking the surface and being made of polyethylene, for example, which layer allows the insulator 3 to expand in the corrugator due to the effect of heat, in other words it behaves in the same way as the plastic foil 10.

1. A piping element comprising at least one elongated element, outside of which there is an insulator having an outer diameter and outside of which there is a corrugated outer sheath having an inner diameter, wherein the piping element is bendable
and the free outer diameter of the insulator is larger throughout than the smallest inner diameter of the corrugated outer sheath.

2. A piping element according to claim 1,
further comprising a watertight layer between the insulator and the corrugated outer sheath.

3. A piping element according to claim 1,
further comprising an adhesion layer between the outer surface of the insulator and the inner surface of the corrugated outer sheath for attaching the insulator and the outer sheath to each other.

4. A piping element according to claim 2,
the layer between the insulator and the outer sheath is formed of plastic foil.

5. A piping element according to claim 2, wherein the watertight layer is an adhesion layer between the outer surface of the insulator and the inner surface of the corrugated outer sheath for attaching the insulator and the outer sheath to each other.

6. A piping element according to claim 5, wherein the layer between the insulator and the outer sheath is formed in plastic foil.

7. A piping element according to claim 3, wherein the layer between the insulator and the outer sheath is formed of plastic foil.

8. A piping element according to claim 1, wherein
the elongated element is a flow pipe.

9. A method of manufacturing a piping element, the method comprising
feeding at least one elongated element,
arranging an insulator outside the at least one elongated element,
conducting the at least one elongated element and the insulator arranged outside it into a corrugator,
forming an outer sheath corrugated with the corrugator outside the insulator,
arranging the free outer diameter of the insulator to be larger throughout than the smallest inner diameter of the corrugated outer sheath, and
reducing the outer diameter of the insulator temporarily before conducting it into the corrugator, whereby the outer sheath is formed upon the insulator and the insulator reverts towards its larger outer diameter, pressing against the inner surface of the outer sheath.

10. A method according to claim 9, wherein
reducing the outer diameter of the insulator is performed by winding around it plastic foil which stretches in the corrugator due to the effect of the heat of the corrugator.

11. A apparatus method according to claim 9,
reducing the outer diameter of the insulator is performed by forming upon it a layer attaching the outer surface of the insulator to the inner surface of the outer sheath.

12. A method according to claim 10, comprising attaching the outer surface of the outer sheath by the plastic foil.

13. A method according to claim 9, wherein
the elongated element is a flow pipe.

14. An apparatus for manufacturing a piping element, the apparatus comprising
means for feeding at least one elongated element,
means for arranging an insulator outside the elongated element,
an extruder as well as a corrugator for forming a corrugated outer sheath outside the insulator, and
means being arranged before the corrugator for reducing the outer diameter of the insulator temporarily.

15. An apparatus according to claim 14, wherein
the means for reducing the outer diameter of the insulator comprise a winding device for winding plastic foil as a helical curve shape outside the insulator.

16. An apparatus according to claim 14, wherein
the elongated element is a flow pipe.
